(19) United States
(12) Patent Application Publication
(10) Pub. No.: US 2009/0000565 A1
(43) Pub. Date: Jan. 1, 2009

(54) SELECTIVELY SEPARABLE PET TOY

(75) Inventor: Lisa McDarren Bryce, Southbury, CT (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/771,183

(22) Filed: Jun. 29, 2007

(51) Int. Cl. A01K 29/00

(52) U.S. Cl. 119/707

(57) ABSTRACT

A pet toy may include a body formed from selectively separable body portions that may define a chamber for holding food or other objects. An object can be received within or removed from the chamber by separating the joined body portions. One or more gripping elements, such as ropes, straps, handles, or the like, may be joined to the toy for separating joined body portions. The gripping elements may also be used to play with the animal, provide dental care for the animal, or provide an object for a person or an animal to hold when carrying or tossing the toy. The body may include substances, such as palatability enhancers, that attract an animal (e.g., a dog or a cat) to the toy. The toy may be composed of a material, such as rubber, safe for use by an animal.

### FIELD OF INVENTION

The present invention generally relates to pet toys, and more particularly to pet toys that attract an animal to the toy and maintain the animal's interest in it.

### BACKGROUND

Pet owners often use pet toys to allow their pets, such as dogs or cats, to engage in natural, yet potentially destructive behaviors such as chewing and tearing. For example, when the pet is chewing on a valuable item, the owner may substitute the pet toy for the item, thus allowing the animal to continue to chew on the pet toy while preserving the valuable item from damage or destruction from the animal's chewing. However, after substituting the toy for an item, the animal may become bored with or otherwise not interested in the toy and return to chewing on a previous item.

One way to attract an animal to a toy is by placing food on or within the toy. The food not only attracts the animal to the toy, but also retains the animal's interest as the animal will generally try to remove the food from the toy. Although the food may retain the animal's interest in the toy, such toys may not satisfy the animal's desire to tear apart an object. Further, in some toys, the food may be placed in a substantially enclosed space formed within the toy through holes that provide access to the space. For such toys, it may be difficult to place the food within the toy and/or clean the toy's interior.

### SUMMARY OF THE INVENTION

One embodiment of the present invention may take the form of a pet toy including a body and a gripping element. The body may include a first portion selectively separable from a second portion. The first and second portions may define a chamber. The gripping element may be joined to the first portion. In some embodiments, the pet toy may further include a second gripping element. In such embodiments, the second gripping element may be joined to the second portion.

A second embodiment of the present invention may take the form of a pet toy including a body and a gripping element. The second embodiment is similar to the first embodiment except the second embodiment may include at least one groove and at least one rib for joining at least two selectively separable portions of the body. The at least two selectively separable portions may define a chamber. The gripping element may be joined to one of the at least two separable portions. One of the at least two separable portions may include the at least one groove. Another of the at least two separable portions may include the at least one rib. The at least one groove may receive the at least one rib when the at least two separable portions are joined.

### BRIEF DESCRIPTION OF THE DRAWINGS

FIG. 1 is a perspective view of an embodiment of a pet toy.

FIG. 2 is another perspective view of the pet toy of FIG. 1, showing the pet toy separated into first and second body portions and a pet treat in dashed lines.

FIG. 3 is a cross-section view of the pet toy of FIG. 1, viewed along line 3-3 in FIG. 1

FIG. 4 is a cross-section view similar to the cross-section view of FIG. 3, showing the pet toy separated into first and second body portions.

FIG. 5 is a side view of another embodiment of a pet toy.

FIG. 6 is a side view of yet another embodiment of a pet toy.

FIG. 7 is a side view of still yet another embodiment of a pet toy.

### DETAILED DESCRIPTION

Described herein are embodiments of a pet toy for use with a domesticated animal, such as a dog, cat, or the like. The pet toy may include a body formed by selectively separable body portions. The joined body portions may define a chamber or hollow space for holding food (e.g., pet treats) or other objects. An object may be placed within or removed from the chamber by separating the joined body portions. One or more gripping elements, such as ropes, straps, handles, or the like, may be joined to the body of the pet toy. The gripping elements may be used to separate joined body portions. For an animal, such as a dog, using a gripping element or the like to separate the joined body portions may satisfy the animal's nature desire to pull on and/or tear apart objects. The gripping elements may also be used to play with the animal (e.g., play tug-of-war), provide flossing or other dental care for the animal, provide an object for a person to grasp when holding, carrying, or tossing the pet toy, or provide an object for the animal to hold when carrying or tossing the toy.

The body may be made of any material generally safe for use (e.g., chewing or licking) by an animal, such as a dog, cat, or the like. In some embodiments, the body may be a flexible plastic or rubber material or any other material that provides both flexibility and puncture resistance or durability when chewed or bitten by an animal. In other embodiments, the body may be a more rigid plastic or rubber material, nylon, or other material that provides puncture resistance and/or durability with minimal flexibility. The gripping elements or the like may be formed from nylon, polyester, rubber, cotton, linen, or any other material generally safe for use by an animal, or some combination thereof.

Palatability enhancers (such as enhancers made wholly or partially from meat or poultry broth concentrate or spray-dried powder, hydrolyzed proteins, yeast and/or yeast extract, or liver), scents (such as spearmint, vanilla, or mint), dental cleaning agents (such as phosphate), flavoring agents (such as garlic; meat flavoring juices, pastes or powders; cheese flavors; fruit flavors; or smoke flavors), colorants (such as natural or synthetic dyes or pigments), breath freshening agents (such as parsley or kelp), and/or other similar types of materials or substances may be added to any of the materials forming the pet toy. The added materials and/or substances may attract an animal to the pet toy, provide nutrients or other health benefits to the animal, increase the visual or other aesthetic appeal of the pet toy, and/or mask odors emitted by the pet toy that people may find offensive or unpleasant.

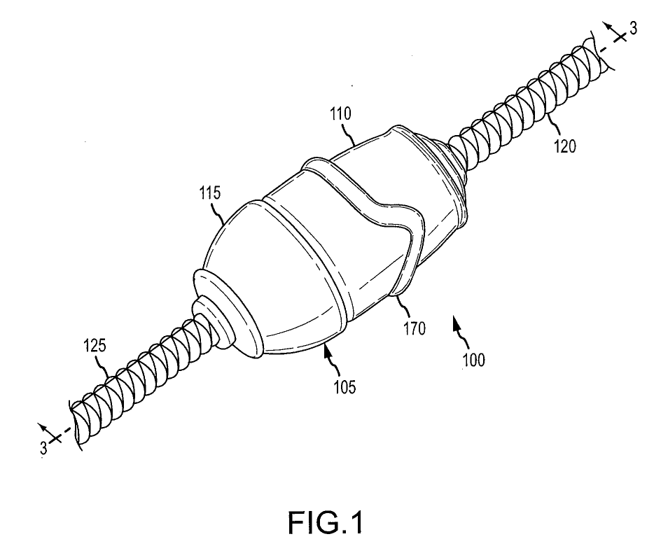

FIG. 1 depicts a perspective view of a pet toy 100. The pet toy 100 may include a body 105 formed from first and second body portions 110, 115 removably joined together. The first body portion 110 may be generally cylindrical, and the second body portion 115 may be partially spherical. In other embodiments, the first and second body portions 110, 115 may take the form of any desired shape. First and second gripping elements 120, 125, such as ropes or the like, may be joined to the first and second body portions 110, 115, respectively. The first and second gripping elements 120, 125 may provide grips for an animal or a person to use to disconnect body portions or play with the toy.

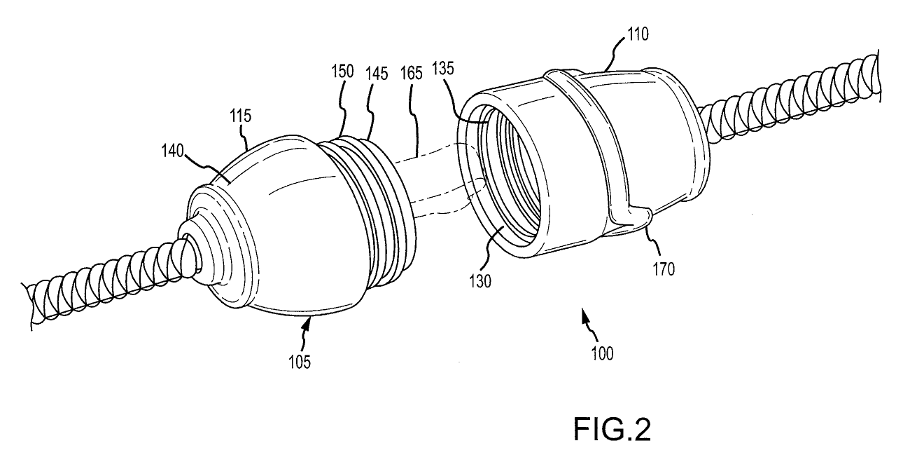

With reference to FIG. 2, the first body portion 110 may define a first body opening 130 to provide access to a first body portion space defined by the first body portion 110. Proximate the first body opening 130, one or more grooves 135 or recesses may be formed on an interior surface of the first body portion. The grooves 135 or recesses may extend partially or wholly around the inner circumference of the first body portion 110.

The second body portion 115 may include a main section 140 and a connection sidewall 145 extending from an end portion of the main section 140. The connection sidewall 145 may be generally cylindrical and may be sized for receipt into the first body portion space through the first body opening 130. In other embodiments, the connection sidewall 145 may take the form of any desired shape sized for receipt within the first body portion.

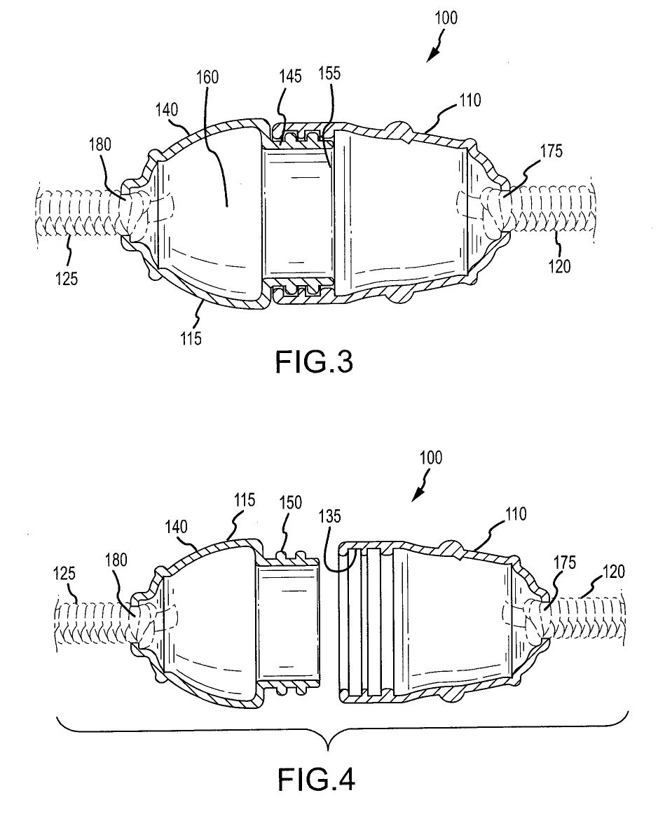

One or more ribs 150 may extend, partially or wholly, around the outer circumference of the connection sidewall 145. The ribs 150 may be sized and arranged to mate with the grooves 135 of the first portion body 110 when the first and second body portions 110, 115 are joined as shown in FIG. 3. Such engagement between the grooves 135 and the ribs 150 securely joins the first body portion 110 to the second body portion 115 in the absence of external forces that pull apart or otherwise separate the first and second body portions 110, 115. The body portions 110, 115 may be joined by pressing or screwing them together until grooves 135 of the first body portion 110 receive the ribs 150 of the second body portion 115.

Although the grooves 135 are shown as formed in the first body portion 110 and the ribs 150 on the second body portion 115, the grooves 135 could be formed in the second body portion 115 and the ribs 150 on the first body portion 110. Further, the grooves 135 may be formed on an outer surface of either body portion and the ribs 150 on an inner surface, if desired. Yet further, the first and second body portions 110, 115 may be configured for the first body portion 110 to include a sidewall or other male type connection for receipt within the second body portion 115. In such a configuration, the connection sidewall or other male type connection may be omitted from the second body portion 115.

With reference to FIG. 3, the second body portion main section 140 and the connection sidewall 145 may define a second body portion space. The second body portion space may be accessed through a second body portion opening 155 defined at the free end of the connection sidewall 145. When the first and second body portions 110,115 are joined, the first and second body portion open spaces may define a chamber 160. Although a single chamber 160 is shown, the first and second portions 110, 115 may contain interior walls or sections that may form two or more chambers when the body portions 110, 115 are joined.

Objects that attract the animal to the pet toy or change a characteristic of the pet toy may be received within the chamber. For example, a pet treat 165 (see, for example, FIG. 2) or other food may be placed within the chamber 160 to attract the animal to the pet toy 100. The pet treat 165 or other food may be any food or liquid suitable for consumption by people or animals, including, but not limited to, dry pet foods, wet pet foods, paste snacks, fruits, nuts, vegetables, candy, and so on. As another example, objects that make noise when the toy 100 is moved may be placed in the chamber 160 to further attract the animal to the toy 100. As yet another example, a buoyant material, such as an open celled foam or the like, may be inserted into the chamber 160 to increase the buoyancy of the pet toy 100.

With reference to FIGS. 3 and 4, the first and second body portions 110, 115 may be separated by pulling them apart. The first and second gripping elements 120, 125 may provide grips for an animal or person to use for separating the body portions 110, 115. For example, an animal may hold onto one gripping element 120 using its teeth and a person may hold the other gripping element 125. Continuing with the example, the animal may pull on the one gripping element 120 and the person on the other. Still continuing with the example, when the animal and the person pull on the gripping elements 120, 125 with sufficient force, the forces holding the ribs 150 within the grooves 135 may be overcome, thus separating the first body portion 110 from the second body portion 115. Such separation may provide the animal with the satisfaction of tearing apart an object and/or allow the animal to obtain food or other items placed into the chamber 160 of the pet toy 100.

Although the foregoing example describes an animal and a person working together to pull apart the first and second body portions 110, 115, an animal working alone may pull apart the body portions 110, 115, a person working alone may pull apart the body portions 110, 115, two or more animals working together may pull apart the body portions 110, 115, or two or more people working together may pull apart the body portions 110, 115. For example, two animals may each hold a gripping element 120, 125 or a body portion 110, 115 in their teeth and work together to pull apart the body portions 110, 115. As another example, an animal may hold one gripping element 125 in its teeth and use a paw to hold the other body portion 110 (i.e., the body portion not connected to the gripping element gripped by the animal) against a surface. Continuing with the example, the animal may separate the body portions 110, 115 by pulling or tugging on the gripping element 125 while maintaining the other body portion 110 substantially stationary using its paw.

Separating the body portions 110, 115 provides access to the chamber 160. Such access may be used to place objects within the chamber 160, remove objects from the chamber 160, and/or replace or remove a gripping element 120, 125 removably joined to a body portion 110, 115. The body portions 110, 115 may also be separated to facilitate cleaning the inner surfaces of the body portions 110, 115. The body portions 110, 115 may be rejoined by pressing or screwing them together until the ribs 150 of the second body portion 115 are received within the grooves 135 of the first body portion 110. Prior to joining the body portions 110, 115 together, a suitably sized object may be placed between the body portions 110, 115 for retention within the chamber 160 formed when the body portions 110, 115 are joined.

The wall thicknesses for the first and second body portions 110, 115 may be selected to provide sufficient flexibility to allow the body portions 110, 115 to deform inwardly towards the chamber 160 when an animal bites the pet toy 100, yet sufficiently thick to minimize the potential for the animal to puncture the body portions 110, 115 with its teeth. The wall thicknesses for first or second body portions 110, 115 with such characteristics may depend upon the body portions' 110, 115 material properties and the shape. For example, when the body portions 110, 115 are formed of rubber and define a chamber 160, the body portions' 110, 115 wall thicknesses may be between approximately ½″ and ⅜″.

With reference to FIGS. 1 and 2, a ridge 170 may extend around an exterior surface of the first body portion 110. The ridge 170 may be integrally formed with the first body portion 110 as shown. In alternate embodiments, the ridge 170 may be joined to the first body portion 110 by another suitable connection method (such as by heat or sonic welding, chemical bonding, mechanical fastening, and so on) or by a combination of connection methods. If desired, the pet toy may include grooves, recesses, or additional ridges formed on or joined to the first body portion 110, the second body portion 115, or both. Grooves, recesses, or ridges may be merely decorative or may provide dental cleaning or gum massaging functions, and grooves or recesses may receive and retain pet treats or other food. The afore-described grooves, recesses and/or ridges are entirely optional.

One or more scent holes (not shown) may be formed in one or more of the body portions 110, 115. The scent holes may be relatively small to allow aromas or scents emitted by treats or other food to escape from the chamber 160 while retaining the food item within the chamber 160. These aromas or scents may be detected by the animal, which may draw the animal to the pet toy 100 or maintain the animal's interest in the pet toy 100. The aromas and scents may also encourage the animal to separate the body portions 110, 115 in order to gain access to the treat or other food item contained within the chamber 160.

A palatability enhancer or scent may be applied on or placed near the inner surfaces of one or more the body portions 110, 115. Applying or placing a palatability enhancer or scent on the inner surface may increase the animal's interest in tearing apart the body portions 110, 115 in order to gain access to the source of the smell. Such application or placement may also cause the animal to want to access the chamber 160 when objects emitting weak or no odors are placed within the chamber 160.

As shown in FIGS. 3 and 4, the first and second gripping elements 120, 125 may be received through first and second body portion holes 175, 180 formed in the first and second body portions 110, 115 respectively. Each gripping element 120, 125 may be knotted at an end portion to removably join the gripping element 120, 125 to its respective body portion 110, 115. Other suitable methods for fixedly or removably joining the gripping elements 120, 125 to the body portions 110 115, such as bonding, adhering, mechanical fastening, and so on, may be used in place of or in combination with using knotted ends to join the gripping elements 120, 125 to their respective body portions 110, 115.

Each gripping element 120, 125 may have a select length and a constant or variable cross-sectional area along the gripping element's length. The lengths for either or both gripping elements 120, 125 may be sufficient for grasping by a person or an animal. The minimal cross-sectional area for either or both gripping elements 120, 125 may be sufficient to resist at least a predetermined amount of tension or other forces that may be imposed on the gripping elements 120, 125 by a person or an animal.

The first and second body portion holes 175, 180 may be co-axially aligned so that the gripping elements' lengths may be selectively co-axially aligned as shown, for example, in FIG. 1. Such co-axial alignment of the gripping elements' lengths may facilitate separating the first body portion 110 from the second body portion 115. The holes 175, 180 may be circular, cruciform shaped, or any other desired shape. The holes 175, 180 may be located at end portions of the first and second body portions 110, 115 as generally depicted in FIG. 1. In other embodiments, the first and second body portion holes 175, 180 may be located at other locations on the first and second body portions 110, 115. The holes 175, 180 may be sized to hold pet treats or other food for the animal. Areas of the first and second body portions 110, 115 around the holes 175, 180 may be sufficiently flexible to allow the holes 175, 180 to expand in order to receive and/or release a pet treat.

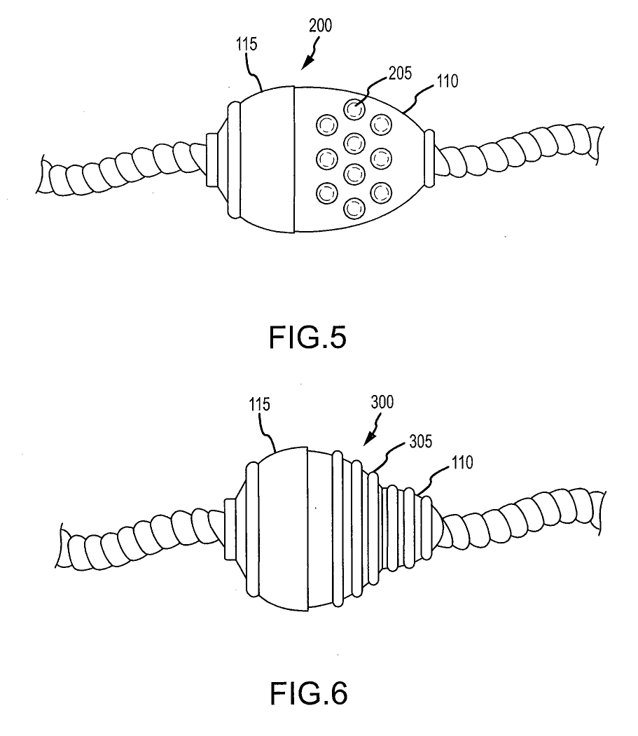

FIG. 5 depicts a second embodiment of a pet toy 200 with separable body portions 110, 115. The second embodiment is similar to the first embodiment except for different surface features. In particular, the second embodiment has multiple circular recesses 205 formed on one of its body portions 110.

FIG. 6 depicts a third embodiment of a pet toy 300 with separable body portions 110, 115. The third embodiment is similar to the first embodiment except for different surface features and a differently shaped body portion. Specifically, one body portion 110 contains multiple, parallel spaced ribs 305 extending around the exterior surface of the body portion 110, and this body portion 110 has a more conical shape.

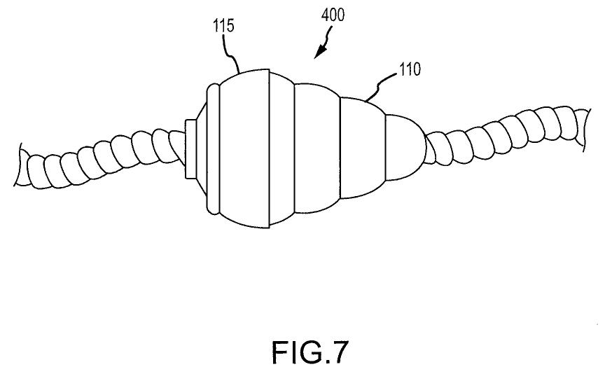

FIG. 7 depicts a fourth embodiment of a pet toy 400 with separable body portions 110, 115. The fourth embodiment is similar to the first embodiment except that the overall body has different shape. More particularly, the body portions 110, 115 when joined form a body resembling a bee hive. To form this shape, one body portion 115 may resemble a bowl and the other body portion 110 may be formed from portions of joined spheres with diameters that generally increase when moving from the gripping element side to the connection side.

Although the body portions 110, 115 are described as joined by a tongue and groove type connection system, the body portions 110, 115 for any embodiment may be joined by any suitable connection method that allows the body portions 110, 115 to be selectively separated. For example, the body portions 110, 115 may be joined by hook and loop fasteners (e.g., Velcro). The hook and loop fasteners may be arranged on each selectively separable body portion to join the body portions 110, 115 in the absence of a force sufficient to overcome the fasteners' connection. As another example, the body portions 110, 115 may be joined by snap fasteners (e.g., snap buttons). The snap fasteners may be arranged on abutting faces of body portions 110, 115 to join the body portions 110, 115. As yet another example, the body portions 110, 115 may be joined by springs (e.g., coil springs). The springs may bias the body portions 110, 115 to a joined position. The body portions 110, 115 may be separated by applying sufficient external forces to overcome the spring forces biasing the body portions 110, 115 together. The foregoing examples are merely illustrative and are not intended to limit the use of other connection mechanisms for joining body portions together that may be selectively separated. Further, any connection mechanism may be used in combination with one or more other connection mechanisms.

For any embodiment of the pet toy, the body 105 may be composed of more than two separable body portions as shown in the figures and described above. For example, three body portions may define the chamber. Each of the three body portions may be removably joined to adjacent body portions for selective separation from the adjacent body portions. Gripping elements may be joined to any or all of the body portions, if desired. The foregoing example is merely illustrative and is not intended to limit the use of more or less body portions, gripping elements, and so on than described in the example.

For any embodiment of the pet toy, types of gripping elements 120, 125 other than ropes or the like, as shown in FIGS. 1-7, may be used in place of or in combination with ropes. For example, handles or other elements defining loops or holes (including ropes or straps formed into loops) may be joined to any of the body portions. These handles and loop-type elements may be composed of any material safe for an animal, such as flexible plastic, nylon, and so on. The handles and loop-type elements may include loops or hoops sufficiently sized for receiving a person's hand or a portion of an animal's mouth therein. The foregoing example is merely illustrative and is not intended to limit the use of other types of gripping elements 120, 125 for grasping by a person or an animal. Further, any type of gripping element 120, 125 may be used in combination with one or more other types of gripping elements 120, 125.

A connection element (not shown), such as a band or strap, may be joined to the body portions. The connection element may be sufficiently long or elastic to allow separation of the body portions for accessing the chamber while remaining connected to each body portion. Such a connection element may keep the body portions joined within proximity of each other when separated, thus reducing the potential for the body portions to be misplaced or lost when not joined together to form the chamber for the pet toy. The connection element may be composed of any elastic or inelastic material that is safe for an animal, such as nylon, rubber, metal and so on. The connection element is entirely optional.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present invention, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A pet toy comprising:
a body including a first portion selectively separable from a second portion;
a chamber defined by the first and second portions; and
a first gripping element joined to the first portion.

2. The pet toy of claim 1, wherein the first gripping element comprises a rope.

3. The pet toy of claim 1, wherein the chamber is sized to contain a pet treat.

4. The pet toy of claim 1, further comprising a second gripping element joined to the second portion.

5. The pet toy of claim 4, wherein the second gripping element comprises a rope.

6. The pet toy of claim 1, wherein the chamber is accessed by separating the first and second portions.

7. The pet toy of claim 4, wherein the first and second portions are separated using the first gripping element.

8. The pet toy of claim 4, wherein the first and second portions are separated using the first and second gripping elements.

9. The pet toy of claim 1, wherein:
one of first and second portions includes at least one groove;
the other of the first and second portions includes at least one rib; and
the at least one groove receives the at least one rib when the first and second portions are joined.

10. The pet toy of claim 1, wherein the first gripping element is removably joined to the first portion.

11. The pet toy of claim 4, wherein the second gripping element is removably joined to the second portion.

12. The pet toy of claim 1, wherein the body includes a palatability enhancer.

13. The pet toy of claim 1, wherein the body comprises a flexible plastic.

14. The pet toy of claim 1, wherein:
the first portion includes a hole; and
the hole receives at least a portion of the first gripping element.

15. A pet toy comprising:
a body including at least two selectively separable portions defining a chamber;
a first gripping element joined to one of the least two selectively separable portions;
one of the at least two separable portions includes at least one groove;
another of the at least two separable portions includes at least one rib; and
the at least one groove receives the at least one rib when the at least two separable portions are joined.

16. The pet toy of claim 15, wherein the first gripping element comprises a rope.

17. The pet toy of claim 15, further comprising a second gripping element joined to another of the at least two selectively separable portions.

18. The pet toy of claim 17, wherein the second gripping element comprises a rope.

19. The pet toy of claim 15, wherein the chamber is accessed by separating the at least two separable portions.

20. The pet toy of claim 15, wherein the at least two portions are separated using the first gripping element.

21. The pet toy of claim 17, wherein the at least two portions are separated using the first and second gripping elements.

22. The pet toy of claim 15, wherein the first gripping element is removably joined to its portion.

23. The pet toy of claim 17, wherein the second gripping element is removably joined to its portion.

24. The pet toy of claim 15, wherein the body comprises a flexible plastic.
